(19) United States
(12) Patent Application Publication
(10) Pub. No.: US 2024/0428023 A1
(43) Pub. Date: Dec. 26, 2024

(54) ANALOG PROCESSING SYSTEM

(71) Applicant: Microsoft Technology Licensing, LLC, Redmond, WA (US)

(72) Inventors: Jannes GLADROW, Cambridge (GB); Hitesh BALLANI, Cambridge (GB); Francesca PARMIGIANI, Cambridge (GB); Christos GKANTSIDIS, Cambridge (GB); Kirill KALININ, Cambridge (GB); Babak RAHMANI, Cambridge (GB); Cheng ZHANG, Cambridge (GB); Daniel CLETHEROE, Cambridge (GB)

(21) Appl. No.: 18/340,641

(22) Filed: Jun. 23, 2023

(51) Int. Cl. G06G 7/16; G06N 3/065

(52) U.S. Cl. CPC G06G 7/16; G06N 3/065

(57) ABSTRACT

Analog system and method for implementing an iterative neural network based model, the system comprising analog vector-by-matrix multiplication circuitry encoding a matrix of weights of an iterative neural network-based model, and analog nonlinearity circuitry encoding a non-linear function arranged in a feedback loop configured to return the output signals from the nonlinearity circuitry as inputs to the vector-by-matrix multiplication circuitry, wherein the system is configured to output a solution vector of values of the iterative neural network based model on convergence of the system.

### BACKGROUND

Deep neural networks can be used for a wide variety of applications, including image processing, machine translation, speech recognition, facial recognition, biological sequence analysis, etc. Neural networks comprise parameters (weights) which are typically learned in training based on large quantities of labelled training data comprising input vectors and corresponding outputs. At inference, the neural network is configured to process previously unseen input vectors to predict their corresponding outputs. For example, an image classification network is configured to take an input representation of an image (for example a matrix or vector of pixel values), and to output a value representing the class or classes appearing in that image (for example a vector of probability values representing the probability that the input image belongs to each of a set of pre-determined classes).

Various architectures are used for deep neural networks. The simplest type of neural network is a feed-forward neural network in which the output of each hidden layer feeds into the subsequent layer as an input. Other architectures such as recurrent neural networks (RNNs) and convolutional neural networks (CNNs) are popular. Transformer networks are a recently developed and commonly used architecture, particularly for language-based applications. Neural networks can be configured to process inputs of various dimensions, including sequential data, text data, image data, etc., and to produce outputs of various types, such as a single value (for example indicating a probability that a given image contains a cat), an image (for example, a generated image for a given input description), or text (for example a translation of the input).

Deep equilibrium models are a formulation of ‘infinite depth’ neural networks that work by feeding the output of each layer (or block of layers) back into the same layer until the outputs converge to a solution. This is based on the observation that in many feedforward weight-tied deep learning models, where ‘weight-tied’ means that the weights are shared across layers, the outputs of hidden layers converge to a fixed point in later layers. By applying a single layer in an iterative loop, the output of the network is determined when the layer outputs converge to a fixed point.

Other types of iterative neural network based models can also be implemented, including neuralODEs.

Deep equilibrium models are typically implemented in digital hardware, such as CPUs, FPGAs, GPUs and ASICs. Specialised digital processors for implementing neural networks and deep learning models, also referred to as hardware AI accelerators, are generally focussed on enabling parallel processing.

### SUMMARY

Described herein is a system and method for implementing an iterative neural network based model in the analog domain. An iterative neural network based model, such as a deep equilibrium model is implemented as a repeating ‘cell’ that applies a weight matrix to a vector of inputs, and a nonlinearity, and feeds the output signal back as input to the ‘cell’. Over time, the signal converges to a fixed output value of the model.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of the present disclosure, and to show how embodiments may be put into effect, reference is made by way of example to the accompanying drawings in which:

FIGS. 1A and 1B show schematic block diagrams of a deep equilibrium model;

FIG. 2 shows a schematic block diagram of an analog implementation of a deep equilibrium model;

FIG. 3 shows a schematic diagram of an example opto-analog system for simulating a deep equilibrium model;

FIG. 4 shows a schematic diagram of an example deep equilibrium model for a ResNet architecture;

FIG. 5 shows a schematic diagram of an example optical vector-by-matrix multiplier using spatial light modulators;

FIG. 6 shows a schematic diagram of an example electronic vector-by-matrix multiplier;

FIG. 7 shows a schematic block diagram of a computer system comprising an analog implementation of a deep equilibrium model;

FIG. 8 shows a schematic block diagram of an example computer system for use with the analog deep equilibrium model implementation.

### DETAILED DESCRIPTION

A potential difficulty with neural network training is the large amount of computer memory needed to both train and implement the neural network, since all the weights of the network are stored, along with all the intermediate values output by the hidden layers. Deep equilibrium models (DEQ) are a recent development to address this. Deep equilibrium models are a type of iterative neural network-based model, in which neural network layers are applied iteratively in a feedback loop until the model reaches a solution state, which may be a steady state which does not change over time (excluding small fluctuations due to noise), or a state of the system after a pre-specified time for convergence. Deep equilibrium models implement an ‘infinite depth’ network by feeding the output back into the same layer until the outputs converge to a solution based on the observation that in many feedforward weight-tied deep learning models, where ‘weight-tied’ means that the weights are shared across layers, the outputs of hidden layers converge to a fixed point in later layers. By applying a single layer in an iterative loop, the output of the network is determined when the layer outputs converge to a fixed point. Similarly, another class of models known as NeuralODEs which iterate the same layer (or group of layers) to determine an output. Models in which a set of neural network layers are applied iteratively in a feedback loop are referred to collectively herein as ‘iterative neural network based models’. The specific embodiments described herein refer to the implementation of deep equilibrium models, but it should be noted that the same principles may be applied to any kind of iterative neural network based model, including Neural ODEs.

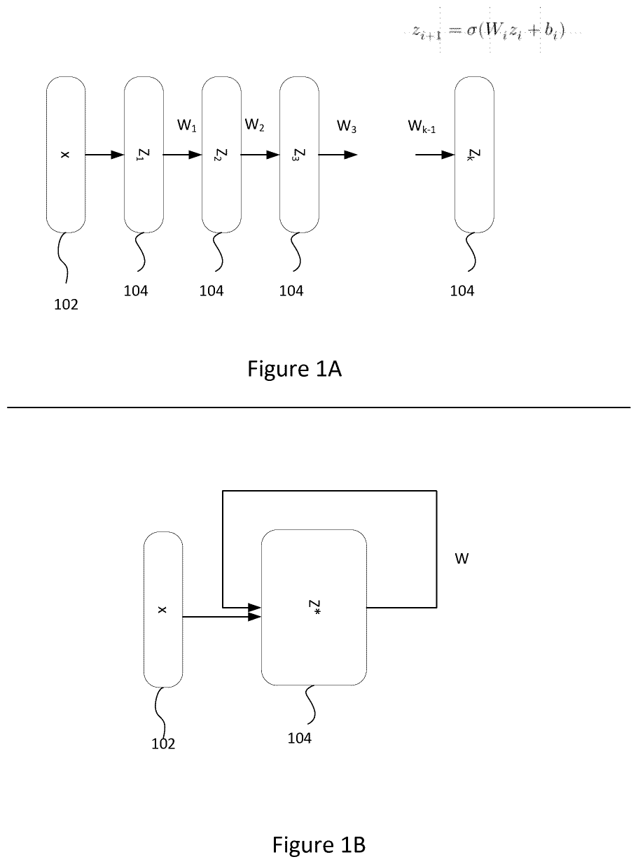

FIG. 1A shows a traditional neural network architecture and FIG. 1B shows a deep equilibrium architecture. As shown in FIG. 1A, the neural network comprises an input layer 102, at which the input to the network, x, is received, followed by multiple hidden layers 104, with activations labelled z. In a standard feedforward network, the output of the previous layer is provided as an input vector to each hidden layer, by which a respective weight matrix Wᵢ is applied and a bias vector bi is added. A nonlinear activation function σ is applied at each hidden layer. After some predetermined number of hidden layers, an output from the network. The output corresponds to the desired product of the network. For example, for an image classification network the output may be a vector of classification probabilities for a predefined set of possible classes. The activations at each hidden layer are computed according to the following equation:

$${z}_{i + 1} = σ ( {W}_{i} {z}_{i} + {b}_{i} ) . \qquad ( 1 )$$

It should be noted that traditional networks are configured to learn different weights at each layer, such that W₁≠W₂, etc. However, when the weights are tied (i.e. shared) across layers, such that each hidden layer uses the same weight matrix W, it is found that the activations converge to a fixed point z*.

This can be reformulated as a feedback loop as shown in FIG. 1B, wherein the input x is provided to the hidden layer, and the output of the hidden layer is fed back as an input to the same hidden layer 104. Since the weights are the same each time, this is equivalent to a neural network as shown in FIG. 1A with ‘tied’ weights and infinite depth.

The input x is also multiplied by a matrix U and ‘injected’ at each layer. As the network progresses through the feedback loop, the value of the activations z are updated according to an update rule:

$${z}_{i + 1} = σ ( {Wz}_{i} + Ux + b ) .$$

The input term Ux and bias term b are constant, and can be treated as a single bias term bₓ, giving the following update rule:

$${z}_{i + 1} = σ ( {Wz}_{i} + {b}_{x} ) .$$

Eventually, the activations converge to a ‘fixed point’ z*(104), which is then output as the output of the network. This is referred to as a deep equilibrium model. This is represented by the following equation:

$${z}^{*} = σ ( {Wz}^{*} + b ) \qquad ( 2 )$$

Deep equilibrium require less computer memory to train than standard feedforward networks, since training is implemented using a root-finding algorithm to compute z* without requiring the intermediate values of z to be stored in memory. Examples of root-finding algorithms include Newton methods and quasi-Newton methods such as Broyden's method. Deep equilibrium models and their advantages are described in Bai, Shaojie, J. Zico Kolter, and Vladlen Koltun. “Deep equilibrium models.” Advances in Neural Information Processing Systems 32 (2019), which is hereby incorporated by reference in its entirety.

Digital hardware provides advantages in terms of flexibility to program algorithms of all kinds. However, digital solutions are also limited by their speed of execution, as well as power consumption. It is predicted that improving performance of digital hardware will be increasingly difficult as fundamental physical limits are approached.

Described herein is an all-analog system for implementing iterative neural network based models, including deep equilibrium models. The system comprises analog vector-matrix multiplication circuitry and nonlinearity circuitry, through which signals are continuously fed back in a loop, thereby simulating equation 2 above. By running an analog device in feedback, it can serve as a highly efficient solver, computing an output to the deep equilibrium model quickly and efficiently. Furthermore, the attractor nature of the deep equilibrium model leads to greater resilience to analog noise of the system, making the system robust to noise. This is because, at each iteration, the system is drawn closer to the attractor, so if noise is applied and the system state is pushed away from your trajectory the attractor still brings the system to a fixed point. Attractors come with so called ‘basins of attraction’. As long as you are within this basin, you will end up at/close to the fixed-point if you iterate long enough. The attractor will work against the noise over time. Analog systems are magnitudes more efficient at matrix multiplication per unit power than graphics processing units, which are typically used for deep learning applications, thus significantly reducing the power consumption used for deep-learning inference. Applying vector-by-matrix multiplication in an all-analog system also avoids the need to fetch weights from memory, which can be costly.

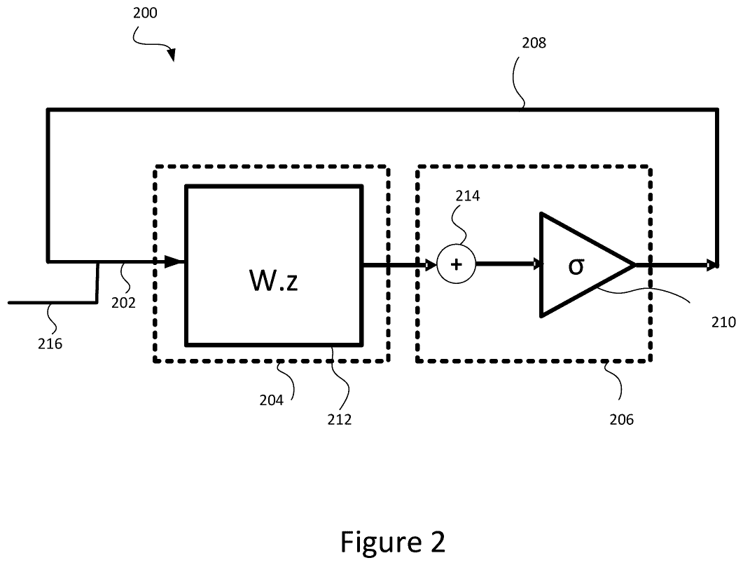

FIG. 2 shows a schematic block diagram of an analog system 200 implementing a deep equilibrium model. The system includes vector-by-matrix multiplication circuitry that encodes the weights of the deep equilibrium model and nonlinearity configured to implement a nonlinear function of the deep equilibrium model, where these operate in a feedback loop. The system outputs an array of signals representing the output of the deep equilibrium model.

In general, the term ‘array’ herein is used to refer to a set of analog signals having a certain measurable property that models a numerical value of a corresponding vector of values, while ‘vector’ is used to refer to the numerical values themselves. However, ‘vector’ may be used as a shorthand to refer to a set of signals representing a vector of values. Any reference herein to mathematical operations being applied directly to physical signals should be understood to refer to a physical transformation of the signals such that the measurable property of the transformed signals corresponds to a result of applying that mathematical operation to the set of numerical values modelled by the physical signals.

It should also be noted that a distinction is made herein between a signal in the abstract and any specific instance of a signal. The input and output signals of each of the components as discussed herein are not limited to any specific values, while any given instance of such a signal refers to the signal having a particular set of values. For example, a ‘starting instance’ of the input signal is used herein to refer to a first input signal input to a given element of the analog hardware, while a ‘feedback instance’ of the input signal is used herein to refer to the continuous input into the analog hardware from the output of the analog hardware.

Note that while FIG. 2 shows a single line representing the direction of the analog signal between components of the system, the signals processed by the system are provided in the form of an array of multiple signals processed in parallel. It should be noted that, throughout the description, unless otherwise specified, references to an input or an output of any component of the analog system 200 are intended to refer to an array of inputs or outputs, and not to any individual signal.

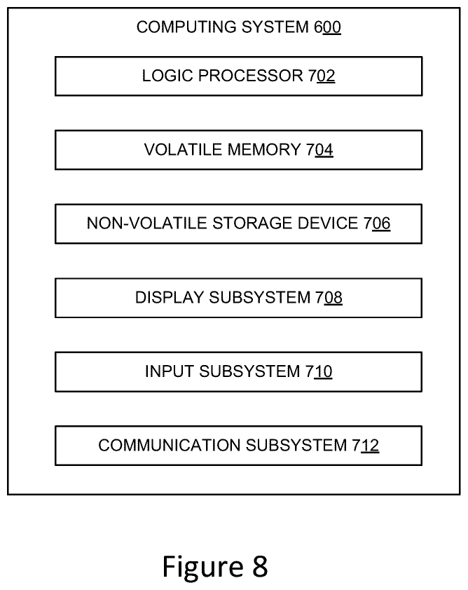

The system includes vector-by-matrix multiplication circuitry 204. The vector-by-matrix circuitry comprises at least a vector-by-matrix multiplier (VMM) 212, but may comprise further analog components configured to apply other operations to a given analog signal, such as converting the signal between the electronic analog domain and the optical analog domain. All signals processed by the system are analog signals (either electronic or optical signals), and no conversion to digital signals is applied during implementation of the deep equilibrium model on the system 200, until conversion of the output signals for storage or communication to a digital computer system or detector, for example as described in FIG. 8. The VMM 212 could be electronic analog circuitry comprising, for example, a matrix of programmable resistive elements such as floating gate field-effect transistors (FETs), reram, memristors, or active transistor multiplier elements, or alternatively an optical VMM implemented with optical components such as a spatial light modulator, ring resonator or Mach-Zehnder interferometer. Some of these examples of electronic and optical vector-by-matrix multiplication components are described in further detail below. Analog vector-by-matrix multiplication hardware is also described in International Patent Application nos. PCT/US2022/014172, PCT/US2022/014173, and PCT/US22/014174, which are hereby incorporated by reference herein in their entirety.

As described above, a possible update equation defining a simple deep equilibrium model is:

$${z}_{i + 1} = σ ( {Wz}_{i} + {b}_{x} ) .$$

According to this equation, each updated vector zᵢ₊₁ determined by multiplying the previous vector zᵢ by a set of weights, adding a bias term, and then applying a nonlinearity. However, due to the circular nature of the deep equilibrium model, the deep equilibrium model can also be implemented with the nonlinearity applied first, i.e.:

$${z}_{i + 1} = W ( σ ( {z}_{i} ) ) + {b}_{x} .$$

In this case, the nonlinear function is first applied previous vector zᵢ, before applying the weights and adding the bias term. In both cases the bias term is dependent on the deep equilibrium model input x.

It is straightforward to ‘absorb’ a constant offset vector, such as the bias term bₓ into a matrix, such as the matrix W and append a 1 to the vector to which the weight vector is applied in either of the above update equations, in order to define the update as a single matrix-by-vector multiplication. A row of zeros is also added to ensure that the matrix is square.

The weight vector in this case is replaced by a modified weight vector:

$$\tilde{W} = [ \begin{matrix}W & {b}_{x} \\ 0 & 0\end{matrix} ]$$

and the vector to which the weights is applied is modified as follows:

$$\tilde{z} = [ \begin{matrix}z \\ 1\end{matrix} ] , or \tilde{σ} ( z ) = [ \begin{matrix}σ ( z ) \\ 1\end{matrix} ] .$$

In this case, the update is reduced to one of:

$${\tilde{z}}_{i + 1} = σ ( \tilde{W} ( {\tilde{z}}_{i} ) ) , or \\ {\tilde{z}}_{i + 1} = \tilde{W} ( \tilde{σ} ( {z}_{i} ) )$$

Described below is an analog circuit to implement either of the above two updates until the system converges to a solution vector.

The analog vector-by-matrix multiplication circuitry 204 takes as an input an array of input signals 202, as shown in FIG. 2, modelling a vector of input values to the multiplication, and transforms this input array, resulting in an array of transformed signals 218 that represents the result of a multiplication of the input values by the matrix of weights of a trained deep equilibrium model. As described above, the weight matrix is a modified weight matrix that encodes both weights of a layer of the deep equilibrium model and the bias terms of the deep equilibrium model. The weights and biases are referred to collectively herein as the weights of the deep equilibrium model. The analog implementation of a deep equilibrium model takes the form of a cell defining a transformation applied continuously to a feedback signal 208. In an analog application of the example deep equilibrium model described above, the ‘cell’ defines a single layer of a neural network having a set of weights W which are applied to the input before computing a non-linear activation function of the resulting vector-by-matrix product.

However, in other embodiments, the transformation may be a composition of multiple ‘layers’ of a neural network comprising different operations. At least one component of the transformation within the cell is a vector-by-matrix multiplication, which is implemented by the analog VMM 212. As shown in FIG. 2, the analog vector-by-matrix multiplier receives an array of inputs 202, where this array of inputs may correspond to either a starting instance 216 representing the initialisation of the system, or to a feedback instance 208 of the inputs, which represents the output z of the model at any given time. The starting state represents the first input to the weight matrix. This could be, for example,

$${\tilde{z}}_{0} = [ \begin{matrix}0 \\ … \\ 0 \\ 1\end{matrix} ] ,$$

such that the first term provided to the weight matrix only picks up the bias term bₓ encoded by the VMM. This term includes the input to the deep equilibrium model as described above, with this term being provided to the nonlinearity function, before feeding the resulting array of signals back to the VMM encoding the model weights. Other initialisations may be used, but some starting signal should be provided to the weight matrix to initialise the state of the system.

The state of the signals of the feedback loop at any given time (which are both output signals and input signals) may be referred to herein as a system state.

The vector of signals of the starting instance 216 could be generated by an analog signal generator, such as a light source, for generating light signals, or an electronic signal generator. In the example provided above, for example, the starting signal can be generated by fixing a single LED channel to encode a value of 1. A measurable property of each of the generated signals corresponds to the numerical value of a respective one of the inputs of the deep equilibrium model. For optical signals, the numerical values may be represented by the intensity or the phase of the optical signal, while for electronic signals, current or voltage may be used to represent the numerical values of the input.

While deep equilibrium models are typically represented as discrete iterative models and implemented as such by software programs executed on conventional computer systems operated in the digital domain, when implemented by an analog system the values of the inputs/outputs of the model are updated continuously. That is, rather than applying a discrete iterative update of the values z over time as the signal is processed by the system 200, which could be described by the following equation:

$${z}_{t + 1} = W tanh ( {z}_{t} ) + {b}_{x} \qquad ( 3 )$$

an analog system simulates the differential equation in its continuous form:

$$\frac{dz}{dt} = W tanh [ z ( t ) ] + {b}_{x} - z ( t ) . \qquad ( 4 )$$

The weights of the deep equilibrium model, including the weights W and the weights U of the bias term, like traditional deep learning models, are learned in training. Training is performed by a standard computer processor configured to perform digital signal processing in the digital domain. More details on training of deep equilibrium models are described, for example, in Bai, Shaojie, J. Zico Kolter, and Vladlen Koltun. “Deep equilibrium models.” Advances in Neural Information Processing Systems 32 (2019), and will not be discussed in further detail herein.

The weights of the deep equilibrium model are encoded within the analog vector-by-matrix multiplier 212. For example, where the vector-by-matrix multiplier 212 takes the form of a spatial light modulator (SLM), and where the input array 202 of signals is a set of intensity-modulated light signals, the modulators within the array of modulators of the SLM are configured to adjust the intensity of the light by factors corresponding to the weights of the deep equilibrium model that were learned in training.

The system also comprises nonlinearity circuitry 206 which applies a nonlinear function to the signal after the weight have been applied to the input. The nonlinearity circuitry 206 could comprise a series of analog components that apply different operations to the signal, with at least one operation being a nonlinear activation function. It should be noted that the term ‘nonlinearity circuitry’ is used herein to refer to any analog components or group of consecutive analog components that apply a non-linear function to the signal.

The nonlinear circuitry 206 comprises at least an activation component 210 which is configured to apply a non-linear activation function to the signal, meaning that the signal is transformed such that the property of the transformed signal takes the value of a result of applying a non-linear function to the numerical value modelled by the signal. However, the nonlinearity circuitry could comprise other components such as an adder 214 configured to add a constant value to the transformed signal before applying an activation function. As in the example above, one possible activation function is tanh. Another popular activation function used in typical neural network implementations is the rectified linear unit (ReLU), which is defined as follows:

$$ReLU ( x ) = max ( 0 , x ) = \{ \begin{matrix}x & if x > 0 \\ 0 & otherwise\end{matrix} .$$

Non-linear functions are implemented using analog electronic or analog optical circuits having components which can control properties of the electronic signal being transmitted, such as voltage and current, to apply the required function. For example, for the ReLU function, this behaviour is easily simulated in an analog electrical system by a diode, which outputs a current in one direction, but not the other, i.e. it allows a positive current to pass through but blocks negative current, thus implementing the function shown above.

As described above, the analog implementation of a deep equilibrium model is a continuous feedback loop through a cell which defines a transformation of the signal. The transformation of a single cell could correspond to a single layer of an infinite neural network architecture to which the deep equilibrium model is equivalent.

Feedback of the array of output signals to the vector-by-matrix multiplier as input signals is implemented by way of a feedback path. This feedback path comprises hardware configured to route the output signal back towards the vector-by-matrix multiplication circuitry 206. In the case of an optical feedback loop, the feedback path could be implemented by waveguides, diffraction gratings, lenses and/or optical fibre cables, while for an electronic feedback loop, the feedback path is implemented by one or more electrical wires carrying the electrical feedback signal.

Alternatively, the cell could be composed of the transformations defined by multiple consecutive layers of a neural network, with the ‘block’ of multiple layers being applied continuously by the implementation of the deep equilibrium model. In this case, the nonlinearity circuitry may comprise more electronic and/or optical analog components such as transistors, resistors, diodes, switches, capacitors, modulators, splitters, etc. in order to implement arbitrarily complex compositions of functions corresponding to the mathematical functions of a cell of the deep equilibrium model applied after the vector-by-matrix multiplication.

It should be noted that the dimensionality of the array of signals remains the same throughout the process, and therefore that the combination of the vector-by-matrix multiplication circuitry and nonlinearity circuitry is configured to produce an output array having the same number of signals as the input array. However, this does not limit the application of the deep equilibrium model to inputs or outputs of a particular size, since unnecessary elements of the input and/or output can be treated as redundant and not used. For example, where the input is an image representation and the output is a single classification value (for example a binary indicator of whether or not a cat is present in the image), a single element of the output vector may be taken as the classification value, and all other elements of the output are treated as redundant. In training the deep equilibrium model, weights would be learned so as to produce an accurate value for this one classification output, without regard for the other output values.

It should be noted that the described order of processing of the feedback signal 208 by the vector-by-matrix multiplication circuitry 204 and the analog nonlinearity circuitry 206 as shown in FIG. 2 is not essential, since the functions are applied continuously in a loop. The vector of signals z output by the nonlinearity circuitry is fed back to the vector-by-matrix multiplication circuitry 204 to continue the process.

The values represented by the array of signals (i.e. the vector z) once the system has converged to a fixed point z*, i.e. once the values of the vector z have stopped changing, is also referred to herein as a solution vector. A convergence condition is defined after which the values of the vector z represented by the state of the system 200 are considered to have converged, and can be output by the system 200 to another system or to a user as the output of the deep equilibrium model. As described above, the array of signals 2 comprises an additional 1 appended to the vector z of values of the model outputs. Once converged, the solution vector of values is determined by excluding this final element from the output array.

The convergence condition is determined by a detector. This may be achieved by comparing several measurements of the feedback signals. A sensor, such as a light meter or a multimeter may be used to measure the state of the system by reading the property of the analog signals to determine the value represented by the signals. Typically, the analog signal is converted to a digital signal as part of this measurement. A detector can be implemented in the form of software implemented on a conventional computer system to compare several measurements of the feedback signals after analog-to-digital conversion, or analog or digital hardware, that interprets the values represented by the signals as read by the sensor to determine that the signals of the system have converged.

One example convergence condition requires that at least two measured values of the vector z as modelled by the analog signals of the system are within a specified distance. A threshold distance may be defined, and the distance between the two measured values of the vector z may be computed by evaluating the vector z based on the sensor readings of the property modelling the values of the vector and by computing a standard distance measure between the resulting numerical vectors. This computation may be carried out in analog hardware, or on software executed on a conventional computer system. Alternatively, a convergence condition may be defined that specifies a time after which the values of the vector z are expected to have converged to a fixed point. In this case, the detector comprises a time measurement device.

It should be noted that measurement of the signals by the sensor may be performed at any point within the feedback loop, including by measuring the input signals 202, transformed signals 218 or output signals. If the system has converged to a steady state, all signals of the system are static, and thus when the detector determines that any one array of signals of the system has converged, it is determined that the system state has converged to a steady state. Alternatively, if the convergence condition is defined by a specified time having elapsed, then all signals are considered to have converged at that time. Convergence of the input signals can thus be detected by detecting convergence of any array of signals within the system. ‘Steady state’ refers to the state of the system once it has converged to within some tolerance of a fixed state. Some noise may be present such that different measurements of the signal properties may give different values even after the system has converged. The tolerance may be defined by a threshold distance within which states are considered static for the purpose of assessing convergence.

The detector is also configured to output the values modelled by the signals as a solution vector of the deep equilibrium model, once the system is determined to have converged. This may be achieved by receiving the values from the sensor used to measure the property of the signals that corresponds to the numerical values of the converged solution z* of the model.

References herein to ‘values’ of a vector or array of signals are intended to refer to the values of a given property of that signal chosen to represent numerical values in the context of the analog system 200. For example, a starting instance 216 of the input vector 202 may be represented as a vector of light signals within the analog system 200, with the values of that starting instance 216 represented as intensities of the light signals, with those intensities being adjusted by the vector-by-matrix multiplier 212 and the nonlinearity circuitry 206 over time until a final fixed set of intensities is reached.

Where the convergence condition is based on a measurement of the values of the array of signals, a measurement device (i.e. a detector) is used to measure the values of the analog property of the signals corresponding to the numerical outputs of the deep equilibrium model. For example, where the values are represented by the light intensity of an array of light signals, a light meter can be used to detect the intensity of each light signal. This can be repeated multiple times, and the values compared, to determine whether the light signals have converged to a solution z*. In some embodiments, the detector may be controlled or programmed by an external computer system to measure the signals at specific times and to compare the measured values to determine whether the system has converged. This computer system may be a standard processor operating in the digital domain. When it is determined that the system has converged to a solution z*, this may be output by the external computer system to a user or to another application or computer system. For example, where the deep equilibrium model implements an image generation model, the vector representation of the output image, as measured from a vector of signals by the detector, may be passed to a computer system to display the image to a user, or to input the image to a further application. The term ‘detector’ may also be used herein for any device or component configured to identify when the convergence condition is met. For example, where a convergence condition is defined as a time after which convergence is expected, the detector used to determine that the convergence condition is met may comprise a clock or other device configured to measure time.

As described above, the implementation of the deep equilibrium model by the system 200 is carried out entirely within the analog domain, but could include both optical and electronic components. Where parts of the system are implemented as optical hardware, the signals are converted from electronic signals to optical signals for processing by the optical hardware, before being converted back to electronic signals for processing by electronic components.

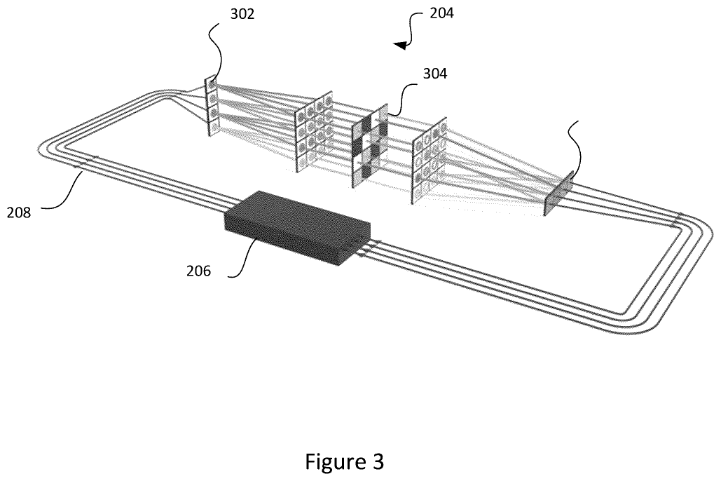

FIG. 3 shows a schematic diagram of an example opto-analog system implementation of a deep equilibrium model, comprising a combination of optical and electronic analog hardware for implementing operations of the deep equilibrium model, described above. An existing opto-electronic system configured for implementing Ising models is described in International Patent Application nos. PCT/US2022/014172, PCT/US2022/014173, and PCT/US22/014174 (the ‘Earlier Applications’), which are herein incorporated by reference in their entirety. Components of the system described in these earlier applications, including the optical vector-by-matrix multiplication hardware, electronic-to-optical and optical-to-electronic converters, and feedback paths, may be used as part of the system described herein for implementing deep equilibrium models.

The starting instance 216 of the vector of input signals 202 is not shown in FIG. 3. As described above, this starting instance is generated as an array of analog signals having a measurable property representing numerical values of an initialisation of the system. Once the starting instance has been processed by the system, a constant feedback loop is established as shown in FIG. 3. The system of FIG. 3 comprises electronic analog nonlinearity circuitry 206, and optical vector-by-matrix multiplication circuitry 204 in the form of an optical vector-by matrix multiplier. It should be noted that the term ‘circuitry’ is used herein to refer to analog components configured to perform a particular function, and can include electronic circuitry, such as wires, transistors, resistors, diodes, transformers, etc., and optical circuitry, such as waveguides, optical fibres, diffraction elements, lenses, and modulators. The optical circuitry may use free-space optics, where light is directed through free space using lenses, diffraction gratings, etc., or integrated optics, where light is directed via optical fibre cables or other waveguides.

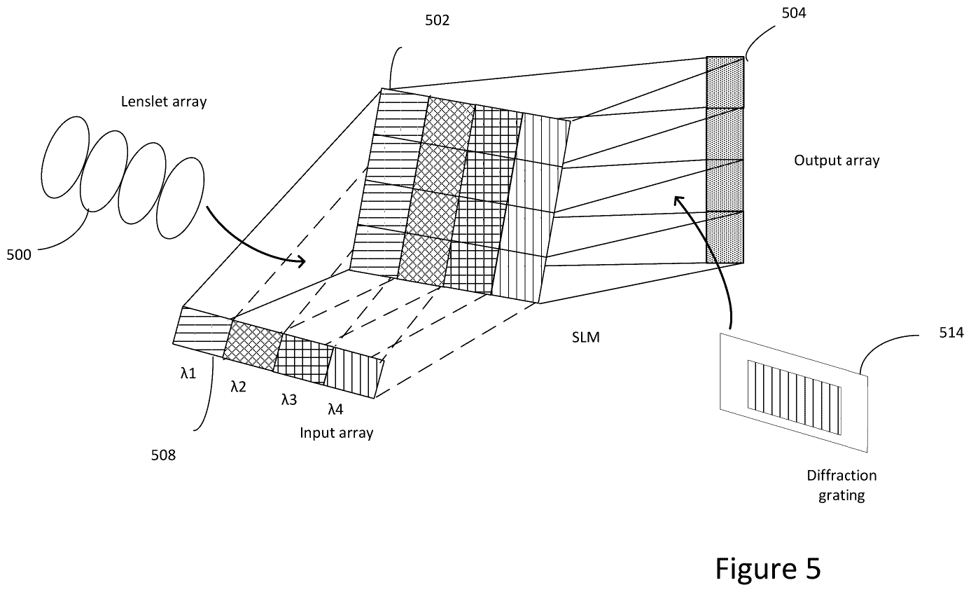

In the system of FIG. 3, the feedback signal 208 reaches the vector-by-matrix multiplication circuitry 204 as a vector of electrical signals, shown by the series of lines, which could be carried along electrical wires. The electrical signals are converted to optical signals by an electrical-to-optical converter 302. This converter could comprise, for example, a set of light-emitting diodes, which emit light at an intensity dependent on the current of the received electrical signal. In the present example, the vector-by-matrix multiplier is implemented using a spatial light modulator 304 and the signals are represented by incoherent light sources such as light-emitting diodes. This is described in more detail below, with reference to FIG. 5.

Simple matrix multiplication is defined as follows. For an input vector v=(v₁, v₂, . . . , v_{N}), and an N×N matrix A, the vector-by-matrix product is computed as:

$$Av = ( \begin{matrix}{A}_{11} & … & {A}_{1 N} \\ ⋮ & ⋱ & ⋮ \\ {A}_{N 1} & … & {A}_{NN}\end{matrix} ) ( \begin{matrix}{v}_{1} \\ {v}_{2} \\ … \\ {v}_{N}\end{matrix} ) = ( \begin{matrix}{A}_{11} {v}_{1} + {A}_{1} {v}_{2} + … + {A}_{1 N} {v}_{N} \\ {A}_{21} {v}_{1} + {A}_{22} {v}_{2} + … + {A}_{2 N} {v}_{N} \\ … \\ {A}_{N 1} {v}_{1} + {A}_{N 2} {v}_{2} + … + {A}_{NN} {v}_{N}\end{matrix} )$$

The input signals are spatially spread out horizontally across the width of the spatial light modulator, to provide input vector for multiplication by each column of the weight matrix (i.e. row of the spatial light modulator in the implementation shown in FIG. 3, though it will be appreciated that the configuration shown may be changed to a horizontal input vector, with a colour for each column of the spatial light modulator by simply rotating the entire multiplier configuration by 90 degrees). The elements of the spatial light modulator correspond directly to the elements of the weights of the vector-by-matrix multiplication of the deep equilibrium model. As described in more detail below, each element of the spatial light modulator is an individual modulator configured to apply a predetermined factor to the received signal at that modulator. This results in a matrix of signals in which each element of the input vector is multiplied by each respective element of the corresponding row of the weight matrix. These signals are added up along each column by combining the resulting array of signals in the vertical direction, resulting in a vector of light signals, which are detected by a photodetector 306 or other optical-to-electrical converter configured to measure the intensity of the light signal and convert it to an electrical signal having a proportional current.

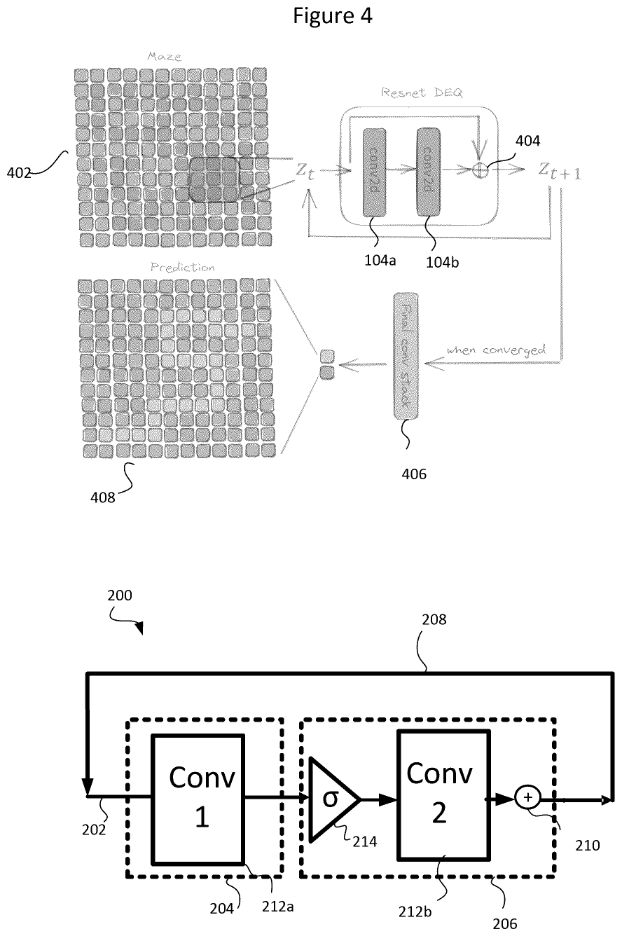

In the example shown in FIG. 3, the nonlinearity circuitry 206 is implemented within the electronic analog domain, and receives the electrical signals as a vector and applies a preconfigured electronic circuit to implement the nonlinear function defined for the given deep equilibrium model to the output of the VMM 204. As described above, the nonlinear function applied by the nonlinearity circuitry 206 could be a composition of multiple functions, which includes at least one non-linear activation function, such as tanh(x) or ReLU, but could also include, for example a further matrix multiplication, or the addition of a constant. The implementation of multiple layers in accordance with a ResNet architecture is described below with reference to FIG. 4.

FIG. 4 shows an example application of a deep equilibrium model formulation of the commonly-used ResNet architecture, for identifying a path out of a maze. The top of FIG. 4 shows the abstract formulation of the ResNet architecture in the form of a deep equilibrium model, while the bottom of FIG. 4 shows the implementation of such a deep equilibrium model to perform the maze solving task. As shown in the top of FIG. 4, the input to the network is a grid defining a maze (shown by the blue squares). A starting square is shown in red, with the exit from the maze shown in green. The task of the deep equilibrium model is to identify a path through the maze that reaches the green square from the red square. While shown as an image, this input would be provided to the deep equilibrium model as a numerical vector or matrix, with the state of each square (maze, not maze, start point, end point) being represented by a numerical value.

The ResNet architecture is a convolutional neural network architecture in which, at each convolutional layer, a kernel of weights is applied as a sliding window across the input matrix, multiplying a subset of elements of the input matrix by the corresponding elements of the kernel. Convolutional networks and convolution are well known in the art and will not be described in detail herein. It should be noted that a convolution over a matrix can be reformulated as a vector-by-matrix multiplication by redefining the input matrix as a vector. In the ResNet architecture, multiple convolutional layers are stacked into a ‘block’, and the output of the block is added to the input to the block, forming a residual block. To implement this architecture with two convolutional layers per block as a deep equilibrium model, the first and second convolutional layers and the addition operation form a cell which is applied continuously in a feedback loop. This is shown in FIG. 4, with two convolutional layers (conv2d) 104a, 104b followed by an addition operation 404. It should be noted that the convolutional layers 104a, 104b are not necessarily identical, and typically have different weights, learned in training. Between the convolutional layers, a nonlinear activation function such as ReLU is applied, which is not shown in FIG. 4.

The task of the model is to determine a set of values of the maze in which the path through the maze is defined, i.e. identify those squares that belong to the path, determining an output representation of the maze that defines a path from the given starting point to the exit. At each step of the deep equilibrium model, an output z is produced. The dimension of the output z is the same at each iteration, and matches the dimension of the input defining the maze. This could be represented as a vector or a matrix of values. In a discrete formulation of the deep equilibrium model, the output zₜ₊₁ at a given timestep is fed back as the input zₜ₊₂ at the next timestep, as shown at the top of FIG. 4. The values of the matrix converge to a set of values for the vector z that define a path through the maze, as shown by the ‘prediction’ at the top of FIG. 4, in which the yellow squares belong to the path, while the red squares do not belong to the path. Yellow and red squares would be represented by numerical values of the output vector. As shown in the top of FIG. 4, once the model has converged to a fixed solution value, a final convolutional stack is applied to the fixed solution value to generate the prediction. References herein to the ‘input’ and ‘output’ of the deep equilibrium model are not intended to be limited solely to the initial input and final output of the given task, but to the input and output the feedback loop defining the deep equilibrium model. Various transformations may be applied to a given input format representing an input to a task, such as a text snippet or an image, to convert it to a suitable form for input to the deep equilibrium model.

The bottom of FIG. 4 shows an example analog implementation of the ResNet deep equilibrium model architecture as executed in an analog system such as the system 200 described above. Input of the initial signals encoding the input to the deep equilibrium model is not shown. As described above with reference to FIG. 2, the analog system 200 comprises vector-by-matrix multiplication circuitry 204 and nonlinearity circuitry 206, which are applied continuously in a loop to a set of analog signals which converge over time to a fixed vector of values.

The VMM 212a is configured to implement the first convolution 104a. This applies the kernel of weights to the array of input signals to generate a transformed vector of signals. This is the first ‘sub-unit’ of the residual cell shown at the top of FIG. 4, having two convolutional layers. As described above, the VMM 212a may be implemented as an optical VMM, one example of which is described below with reference to FIG. 5, or an electronic VMM, implemented for example using an array of memristors, floating gate field effect transistors (FETs), reram, or active transistor multiplier elements. After the first convolutional layer is applied, the resulting transformed signals are passed to the nonlinearity circuitry, and a nonlinear activation function 214, such as ReLU is applied. In the present example, this is followed by a VMM 212b configured to implement the second convolution 104b. The VMM 212b may be implemented in the same form (i.e. optical or electronic) as the first VMM 212a, or they may be different. After the second convolution, an addition operation is applied to the signals output from the second VMM, implementing the addition 404 of the residual input described above. The combination of the nonlinear activation, second convolution and addition forms an overall non-linear function applied by the nonlinear circuitry 206 in each loop. While the top of FIG. 4 shows the deep equilibrium model as a discrete iterative loop in which the vector of values is updated at each discrete iteration, when implemented on the analog system 200, this update of the signal is a continuous implementation of an ordinary differential equation, such as a version of equation (4) above adapted to the ResNet neural network architecture.

The output of the nonlinear circuitry 206 is a vector of feedback signals 208, which are provided to the VMM to implement the first convolutional layer again, in line with the loop shown at the top of FIG. 4. A detector is used to sample values modelled by the feedback signals 208 over time to determine whether convergence criteria are met. If the detector determines that the values modelled by the feedback signals (or input, transformed, or output signals, since convergence of any array of signals of the system indicates that the entire system has converged) have converged to some fixed solution vector of values, these are output by the system 200 shown in FIG. 4. This could be output to a further analog or digital system to apply a final convolutional stack or other output transformation to the solution vector to an output suitable for representing the output of the given task, i.e. a representation of the maze identifying the path through the maze.

FIG. 5 shows an example optical VMM 212 for computing vector-by-matrix multiplication as part of an analog implementation of a deep equilibrium model. This configuration comprises an input array 508 of light sources, a micro-optics array 500, a spatial light modulator (SLM) 502, a second micro-optics array 514 and an output array of light signals which are detected at an array of photodetectors, not shown in FIG. 5.

To use a spatial light modulator for vector-by-matrix multiplication, the vertical axis of the SLM needs to provide different weights even for the same optical source, so that the whole functionality of the vector-by-matrix multiplication is achieved. This is because, for matrix multiplication, the input vector needs to be multiplied by each row of the matrix A to generate the full output vector, as described above. The SLM 508 comprises modulators arranged in an array, with the losses applied by each modulator reflecting the weights of the matrix to be applied to the input, i.e. a row of the modified SLM encodes the weights in a row of a matrix W of weights of the deep equilibrium model. As described above, each element of the transformed vector of signals output by the VMM 212 is computed by multiplying the input vector by a respective column of the matrix. Thus, each of the input signals needs to be processed to be spread out vertically such that they hit each row of the SLM 502, corresponding to a series of vector-by-vector multiplications.

A single input array 508 comprises the set of input signals 202 (which could correspond to the starting instance 216 or any feedback instance 208). As described above with reference to FIG. 3, these signals may be generated using a set of light-emitting diodes (LEDs) configured to convert an electrical current into a light signal. This vector is passed through a micro-optics array 500 having a particular geometry that causes the signals to spread out vertically, while collimating the beam in the horizontal direction of the SLM 502. This allows more input signals to be simultaneously processed at a single SLM. A micro-optics array as in FIG. 5, enables scaling to more signals than a single signal. A micro-optics array improves the collimation properties of the beam in both directions.

The SLM 502 comprises a two-dimensional array of modulators, each element of the array applying a respective weight to the received input signal. A similar configuration is expected for the modulated signals after they are bounced off the SLM 502.

In embodiments, the output signals may be directed from the element 514 via one or more micro-optics, to direct the signals into a beam at the correct vertical height to be detected using incoherent addition at the photodetector corresponding to the output vector element represented by that beam. E.g. another micro-optics array may also be included before the photodetector array.

The photodetector array 504 is arranged as a set of photodetectors in a vertical array, each combined signal directed from the micro-optics element 514 corresponding with a different respective output signal of the vector of output signals. It should be noted that ‘input’ and ‘output’ are used with reference to FIG. 5 to refer to the input and output signals of the multiplication operation only. The output signals referred to in this figure correspond to the transformed signals referred to earlier in the context of the analog system 200 applying a deep equilibrium model.

An analog system 200 which uses a vector-by-matrix multiplier architecture described above allows simultaneous processing of multiple elements of an input vector of the deep equilibrium model. This may be further scaled to enable even larger numbers of inputs by splitting each beam into multiple beams which are directed to a configuration of multiple SLMs 502.

Optical vector multiplication has also been implemented by a number of existing technologies, such as spatial light modulators which use wavelength division multiplexing, ring resonators, and Mach Zehnder interferometers, as described in the Earlier Applications. Such technologies are also described for example in K. Kitayama et al, “Novel frontier of photonics for data processing-Photonic accelerator”, APL Photonics 2019, https://doi.org/10.1063/1.5108912., which is incorporated herein by reference in its entirety. SLM VMM implementations do not use wavelength division, and instead use a single optical source, and use coherent addition at the photodetectors to compute the weighted sum for each element of the output array.

As described above, the VMM can also be implemented by electronic analog components, such as an array of memristors, FETs, reram, or active transistor elements, which are configured to apply a multiplicative factor to an input voltage, generating an output current.

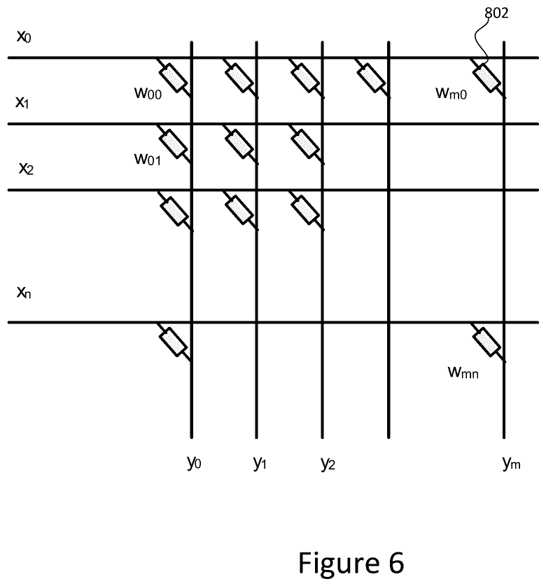

FIG. 6 shows an example implementation of an electronic analog vector-by-matrix multiplier for transforming a set of analog signals representing an input vector (x₀, x₁, . . . , xₙ) by a matrix of weights W_{NM}. It should be noted that the terms ‘input’ and ‘output’ in the present context refer to the direct input and output to the vector-by-matrix multiplier, and do not necessarily correspond to inputs and outputs to any model implemented in the system 200 described elsewhere herein. It will be understood that the input signals to the vector-by-matrix multiplication circuitry is dependent on the specific implementation.

In the example shown in FIG. 6, the input values are modelled by a voltage of the input signals. The matrix of weights is encoded by an array of resistive elements programmable to apply a fixed multiplicative factor to a property of each input signal. Each element of the array corresponds to a respective element of the weight matrix W. In this example, the matrix of weights is encoded by a crossbar arrangement of memristors 802, each memristor wᵢⱼ configured to receive an input signal having a voltage of xᵢ, and to output a current representing the multiplication of the weight corresponding to that memristor with the input signal xᵢ. This multiplication is based on Ohm's law. The output signal of each memristor 802 of a given column of the crossbar array is provided to an output channel for that column. The current of the signals is added by combining the signals. This is based on Kirchhoff's law The resulting currents are thus added along the columns to compute an array of output currents, the output current for each column representing a respective element of the output vector y.

A similar configuration could be used to implement electronic vector-by-matrix multiplication using other types of resistive elements, including floating gate field-effect transistors (FETs) or active transistor multiplier elements. It will be appreciated that the system described herein is not limited to any particular implementation of the vector-by-matrix multiplier, and that any analog circuitry suitable for applying multiplicative factors to modelling properties of analog signals and adding the resulting signals can be arranged to perform such an operation.

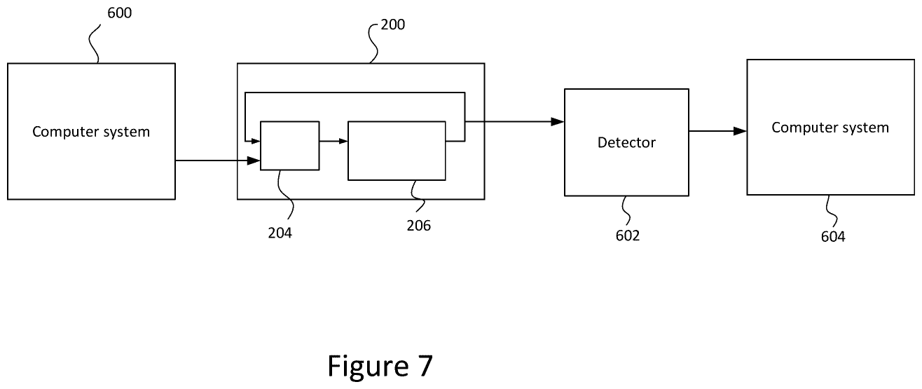

The analog system described herein has a broad range of applications. Any deep neural network architecture can be reformulated as a deep equilibrium model. Examples of neural network architectures that may be implemented include recurrent neural networks, transformer models, and convolutional models. One example application of a neural network is automatic image creation from text. To perform this function, a diffusion model is defined to convert images of pure noise into actual images of, say, people. For example, a convolutional architecture such as U-Net, or ResNet as described above with reference to FIG. 4, may be chosen and applied iteratively to its own output with the initial image consisting of pure noise. An iterative model of the chosen architecture is trained to learn the weights of the model. This training is performed on a conventional computer system in the digital domain. The trained model can then be implemented in an analog system as described above. Deep equilibrium models and iterative neural network models can be used for any application for which a neural network can be applied, wherein the inputs and outputs to the deep equilibrium are processed by a conventional computer system in the digital domain. An example system utilising a deep equilibrium model implementation in the analog domain in combination with digital computer systems is shown in FIG. 7.

The deep equilibrium model may be trained by the computer system 600 shown in FIG. 7, or some other computer system, using a software program for training a deep equilibrium model by applying a root-finding algorithm as mentioned above. The weights of the deep equilibrium model are determined and used to configure the vector-by-matrix multiplication circuitry 204 and/or the nonlinearity circuitry 206 of the analog system to implement the weights. The inputs of the deep equilibrium model are received via a computer system 600 and used to configure the weights of the VMM. For the example image generation application, the input is a segment of text from which an image should be generated. This could be input to the computer system 600 by a user of the computer system 600, or received by the computer system from a database or cloud-based system.

The computer system 600 is a conventional computer system comprising memory and processors configured to perform computation in the digital domain. The computer system may apply some pre-processing steps to convert the input text to a numerical vector representation. This can be achieved by applying a trained word embedding model to convert an input text into a numerical vector. Other transformations may be applied to the numerical vector before converting the vector into analog form. The analog system 200 may be manually configured to implement the weights and bias terms of the deep equilibrium model by manually adjusting the components of the vector-by-matrix multipliers, such as the light modulators, resistors, memristors etc., or a computer system may be configured to control the relevant properties of the components automatically based on the trained weights. A program can be applied to reformulate the trained models in such a way that they can be written to the spatial light modulator, or any other hardware implementation of a VMM. A starting input array is also provided to the analog system 200.

The analog system 200 processes the input analog signals continuously as described above, until some convergence criteria on the signal values is met. As mentioned above, in preferred embodiments, the convergence criteria are based on multiple measurements of the measurable property of the signals representing the underlying numerical values of the deep equilibrium model. For example, convergence criteria may be determined to have been met once a detector determines that two or more measurements of the feedback signals 208, measured a predetermined time interval apart, are within some threshold distance of each other.

A detector 602 is used to measure the values represented by the signals. As described above, the array of signals correspond to a vector of numerical values representing the output of the deep equilibrium model. The detector 206 determines convergence of the system, which could be based on the measurements of a sensor or based on some other convergence criteria such as an elapsed time and outputs the system state, i.e. the values represented by the feedback signals, once the system has converged, to a further computer system. Various types of sensors may be used, such as an ammeter, which measures current, or a light meter which measures light intensity. As described above, the detector may be implemented as a software program implemented on a conventional computer system, by analog hardware such as electronic circuits comprising resistors, transistors, diodes, wires, etc., optical hardware including optical fibres, waveguides, lenses, diffraction elements, modulators, etc., or digital hardware such as FPGAs, program- and application-specific integrated circuits (PASIC/ASICs), program- and application-specific standard products (PSSP/ASSPs), system-on-a-chip (SOC), or complex programmable logic devices (CPLDs), or some combination of software, analog hardware and/or digital hardware. While shown as a separate component of FIG. 7, the detector may be implemented on computer system 600 or computer system 604. The output of the deep equilibrium model as output by the detector 602 is a vector of numerical values.

However, the application to which the deep equilibrium model is applied may require an output of a different format. In the example of image creation, for example, the output is a vector of numerical values which can be mapped to an image. To generate the image, the numerical values of the signals detected by the detector 602 are output to a computer system, which can apply further transformations to the numerical solution vector to convert it to an image. For example, a trained decoder architecture may be configured to convert the numerical representation output by the detector as the state of the analog system 200 to a set of pixel values defining an image. The computer system 604 may be the same computer system 600 used to process the initial input to the task or a different computer system. The computer system may be configured to display the resulting image within a user interface in response to a user's input text string or to store the image to a database.

An analog implementation of a deep equilibrium model may be made available to a user via a cloud-based service. The user may provide a set of inputs to a pre-trained deep equilibrium model via a user device connected to the cloud-based service, which comprises the computer system 600, analog system 200 and computer system 604 shown in FIG. 7. The system of FIG. 7 is then applied as described above to generate an output at computer system 604 suitable for output to the user of the device and corresponding to the set of inputs provided. The computer system 604 of the cloud-based service then communicates the output to the user device via the cloud network.

FIG. 8 schematically shows a non-limiting example of a computing system 700, such as a computing device or system of connected computing devices which can be configured to implement the digital processing of the computer system 600 and 604 described above before and after the application of the analog deep equilibrium model, as well as the detector 602 and the training of the deep equilibrium model in the digital domain. Computing system 600 is shown in simplified form. Computing system 700 includes a logic processor 702, volatile memory 704, and a non-volatile storage device 706. Computing system 700 may optionally include a display subsystem 708, input subsystem 710, communication subsystem 712, and/or other components not shown in FIG. 8.

Logic processor 702 comprises one or more physical (hardware) processors configured to carry out processing operations. For example, the logic processor 702 may be configured to execute instructions that are part of one or more applications, programs, routines, libraries, objects, components, data structures, or other logical constructs. The logic processor 702 may include one or more hardware processors configured to execute software instructions based on an instruction set architecture, such as a central processing unit (CPU), graphical processing unit (GPU) or other form of accelerator processor. Additionally or alternatively, the logic processor 702 may include a hardware processor(s)) in the form of a logic circuit or firmware device configured to execute hardware-implemented logic (programmable or non-programmable) or firmware instructions. Processor(s) of the logic processor 702 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor 702 may be virtualized and executed by remotely accessible, networked computing devices configured in a cloud-computing configuration. In such a case, these virtualized aspects are run on different physical logic processors of various different machines.

Non-volatile storage device 706 includes one or more physical devices configured to hold instructions executable by the logic processor 702 to implement the methods and processes described herein. When such methods and processes are implemented, the state of non-volatile storage device 706 may be transformed—e.g., to hold different data. Non-volatile storage device 706 may include physical devices that are removable and/or built-in. Non-volatile storage device 606 may include optical memory (e g., CD, DVD, HD-DVD, Blu-Ray Disc, etc.), semiconductor memory (e g., ROM, EPROM, EEPROM, FLASH memory, etc.), and/or magnetic memory (e.g., hard-disk drive), or other mass storage device technology. Non-volatile storage device 706 may include non-volatile, dynamic, static, read/write, read-only, sequential-access, location-addressable, file-addressable, and/or content-addressable devices.

Volatile memory 704 may include one or more physical devices that include random access memory. Volatile memory 704 is typically utilized by logic processor 702 to temporarily store information during processing of software instructions. Aspects of logic processor 702, volatile memory 704, and non-volatile storage device 706 may be integrated together into one or more hardware-logic components. Such hardware-logic components may include field-programmable gate arrays (FPGAs), program—and application-specific integrated circuits (PASIC/ASICs), program- and application-specific standard products (PSSP/ASSPs), system-on-a-chip (SOC), and complex programmable logic devices (CPLDs), for example. The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via logic processor 702 executing instructions held by non-volatile storage device 706, using portions of volatile memory 704.

Different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 708 may be used to present a visual representation of data held by non-volatile storage device 706. The visual representation may take the form of a graphical user interface (GUI). For example, as described above, for an image creation application, the image represented by the output of the deep equilibrium model may be displayed to a user via a graphical user interface of the computer system 604, or alternatively the computer system 604 may be connected via a network to a user device having a graphical user interface configured to display the image.

As the herein-described methods and processes change the data held by the non-volatile storage device, and thus transform the state of the non-volatile storage device, the state of display subsystem 708 may likewise be transformed to visually represent changes in the underlying data. Display subsystem 608 may include one or more display devices utilizing virtually any type of technology. Such display devices may be combined with logic processor 702, volatile memory 704, and/or non-volatile storage device 606 in a shared enclosure, or such display devices may be peripheral display devices. When included, input subsystem 710 may comprise or interface with one or more user-input devices such as a keyboard, mouse, touch screen, or game controller.

In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 712 may be configured to communicatively couple various computing devices described herein with each other, and with other devices. Communication subsystem 712 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 700 to send and/or receive messages to and/or from other devices via a network such as the internet. For example, as described above, the computer system 600 may be connected to a user device via a cloud network or the internet, via which user inputs can be transmitted to the computer system 600 and outputs of the model may be communicated to a user device.

The term computer readable media as used herein may include computer storage media. Computer storage media may include volatile and non-volatile, removable and nonremovable media (e.g., volatile memory 604 or non-volatile storage 606) implemented in any method or technology for storage of information, such as computer readable instructions, data structures, or program modules. Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by a computing device (e.g. the computing system 600 or a component device thereof). Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct wired connection, and wireless media such as acoustic, radio frequency (RF), infrared, and other wireless media.

A first aspect herein provides a system comprising: analog vector-by-matrix multiplication circuitry encoding a matrix of weights of an iterative neural network-based model and configured to transform an array of input signals, each input signal of the array of input signals modelling a respective value of an input vector, resulting in a vector of transformed signals, each transformed signal of the array of transformed signals modelling a value of a respective element of a matrix product of the input vector and the matrix of weights, wherein the analog vector-by-matrix multiplication circuitry arranged to receive a starting instance of the array of input signals; analog nonlinearity circuitry encoding a non-linear function and configured to apply a nonlinearity operation to the array of transformed signals, resulting in an array of output signals; a feedback path configured to return the array of output signals as a feedback instance of the array of input signals to the analog vector-by-matrix multiplication circuitry; and a detector configured to: detect convergence of the system to a state in which the array of input signals models a solution vector of values, and output the solution vector of values as an output of the iterative neural network based model.

The matrix of weights encoded by the analog vector-by-matrix multiplication circuitry may comprise a vector of bias elements, each bias element dependent on a respective input value of an input vector to the iterative neural network based model.

The nonlinear function may comprise a vector-by-matrix multiplication, and wherein the analog nonlinearity circuitry comprises further analog vector-by-matrix multiplication circuitry, the further analog vector-by-matrix multiplication circuitry being configured to implement the further vector-by-matrix multiplication.

The detector may be configured to measure a property of each of the input signals of the array of input signals at two or more time instances, and compare the measured property values of the array of input signals between the time intervals, thereby detecting convergence of the system.

The array of input signals may be an array of optical input signals, wherein the analog vector-by-matrix multiplication circuitry is an optical vector-by-matrix multiplier.

The iterative neural network-based model may be a deep equilibrium model.

The system may comprise an analog signal generator configured to generate the starting instance of the array of input signals.

The analog signal generator may comprise a light source configured to generate an array of original optical signals; and a modulator configured to modulate a property of each original optical signal of the vector array of original optical signals to encode a respective initialization value.

The analog signal generator may comprise an electrical-to-optical converter configured to generate the starting instance of the array of input signals as an array of optical input signals based on an vector array of electrical input signals, each electrical input signal encoding modelling a respective initialization value.

The optical vector-by-matrix multiplier may comprise one of: a spatial light modulator; a Mach-Zehnder interferometer; and a ring resonator.

For each input signal, the property encoding the respective input value of the iterative neural network-based model may be one of: intensity; current; voltage; and phase.

The analog vector-by-matrix multiplication circuitry may comprise one of: an array of memristors; an array of field-effect transistors; and an array of active transistor multiplier elements.

The nonlinear function may comprise at least one of: a tanh function; a rectified linear unit (ReLu).

The nonlinearity circuitry may comprise at least one of: a transistor; and a diode.

The system may be connected to a computer system performing an image creation task, the computer system configured to generate a digital representation of the inputs of the iterative neural network-based model based on an image creation input; wherein the analog vector-by-matrix multiplication circuitry is configured to encode the matrix of weights of the iterative neural network-based model based on the digital representation of the inputs of the iterative neural network-based model received from a first computer system; and wherein the detector is configured to output the solution vector of values to the computer system as a representation of an output image of the image creation task, wherein the computer system is further configured to create a digital image based on the solution vector of values.

A second aspect herein provides a method comprising: receiving an input instance of an array of analog input signals; a) transforming the array of analog input signals using analog vector-by-matrix multiplication circuitry, the analog vector-by-matrix multiplication circuitry encoding a matrix of weights of the iterative neural network based model, resulting in a vector of transformed signals, each transformed signal of the array of transformed signals modelling a respective value of a matrix product of the input vector and the matrix of weights; b) applying a nonlinearity operation to the array of transformed signals using analog nonlinearity circuitry, the nonlinearity circuitry encoding a non-linear function, thereby generating an array of output signals; c) returning the array of output signals as a feedback instance of the array of input signals to the analog vector-by-matrix multiplication circuitry; continuing a)-c) until a convergence condition is met; and outputting the values modelled by the array of output signals as a solution vector of the iterative neural network based model.

The convergence condition may be met when a first measurement of a property of the array of output signals taken at a first time and a second measurement of a property of the array output signals taken at a second time are within a pre-defined threshold distance to each other.

The convergence condition may be based on an elapsed time.

The array of analog input signals may be an array of optical input signals, and wherein the analog vector-by-matrix multiplication circuitry is an optical vector-by-matrix multiplier.

It will be appreciated that the above embodiments have been disclosed by way of example only. Other variants or use cases may become apparent to a person skilled in the art once given the disclosure herein. The scope of the present disclosure is not limited by the above-described embodiments, but only by the accompanying claims.

1. A system comprising:
analog vector-by-matrix multiplication circuitry encoding a matrix of weights of an iterative neural network-based model and configured to transform an array of input signals, each input signal of the array of input signals modelling a respective value of an input vector, resulting in a vector of transformed signals, each transformed signal of the array of transformed signals modelling a value of a respective element of a matrix product of the input vector and the matrix of weights, wherein the analog vector-by-matrix multiplication circuitry is arranged to receive a starting instance of the array of input signals;
analog nonlinearity circuitry encoding a non-linear function and configured to apply a nonlinearity operation to the array of transformed signals, resulting in an array of output signals;
a feedback path configured to return the array of output signals as a feedback instance of the array of input signals to the analog vector-by-matrix multiplication circuitry; and
a detector configured to:
detect convergence of the system to a state in which the array of input signals models a solution vector of values, and
output the solution vector of values as an output of the iterative neural network based model.

2. A system according to claim 1, wherein the matrix of weights encoded by the analog vector-by-matrix multiplication circuitry comprises a vector of bias elements, each bias element dependent on a respective input value of an input vector to the iterative neural network based model.

3. A system according to claim 1, wherein the nonlinear function comprises a vector-by-matrix multiplication, and wherein the analog nonlinearity circuitry comprises further analog vector-by-matrix multiplication circuitry, the further analog vector-by-matrix multiplication circuitry being configured to implement the further vector-by-matrix multiplication.

4. A system according to claim 1, wherein the detector is configured to measure a property of each of the input signals of the array of input signals at two or more time instances, and compare the measured property values of the array of input signals between the time intervals, thereby detecting convergence of the system.

5. A system according to claim 1, wherein the array of input signals is an array of optical input signals, and wherein the analog vector-by-matrix multiplication circuitry is an optical vector-by-matrix multiplier.

6. A system according to claim 1, wherein the iterative neural network-based model is a deep equilibrium model.

7. A system according to claim 1, comprising an analog signal generator configured to generate the starting instance of the array of input signals.

8. A system according to claim 7, wherein the analog signal generator comprises:
a light source configured to generate an array of original optical signals;
a modulator configured to modulate a property of each original optical signal of the vector array of original optical signals to encode a respective initialization value.

9. A system according to claim 7, wherein the analog signal generator comprises an electrical-to-optical converter configured to generate the starting instance of the array of input signals as an array of optical input signals based on an vector array of electrical input signals, each electrical input signal encoding modelling a respective initialization value.

10. A system according to claim 5, wherein the optical vector-by-matrix multiplier comprises one of:
a spatial light modulator;
a Mach-Zehnder interferometer; and
a ring resonator.

11. A system according to claim 1, wherein, for each input signal, the property encoding the respective value of the input vector is one of:
intensity;
current;
voltage; and
phase.

12. A system according to claim 1, wherein the analog vector-by-matrix multiplication circuitry comprises one of:
an array of memristors;
an array of field-effect transistors; and
an array of active transistor multiplier elements.

13. A system according to claim 1, wherein the nonlinear function comprises at least one of:
a tanh function;
a rectified linear unit (ReLu).

14. A system according to claim 1, wherein the nonlinearity circuitry comprises at least one of:
a transistor; and
a diode.

15. A system according to claim 1, wherein the system is connected to a computer system performing an image creation task, the computer system configured to generate a digital representation of the inputs of the iterative neural network-based model based on an image creation input;
wherein the analog vector-by-matrix multiplication circuitry is configured to encode the matrix of weights of the iterative neural network-based model based on the digital representation of the inputs of the iterative neural network-based model received from a first computer system; and
wherein the detector is configured to output the solution vector of values to the computer system as a representation of an output image of the image creation task, wherein the computer system is further configured to create a digital image based on the solution vector of values.

16. A method comprising:
receiving an input instance of an array of analog input signals;
transforming the array of analog input signals using analog vector-by-matrix multiplication circuitry, the analog vector-by-matrix multiplication circuitry encoding a matrix of weights of the iterative neural network based model, resulting in a vector of transformed signals, each transformed signal of the array of transformed signals modelling a respective value of a matrix product of the input vector and the matrix of weights;
applying a nonlinearity operation to the array of transformed signals using analog nonlinearity circuitry, the nonlinearity circuitry encoding a non-linear function,
thereby generating an array of output signals;
returning the array of output signals as a feedback instance of the array of input signals to the analog vector-by-matrix multiplication circuitry;
continuing a)-c) until a convergence condition is met; and
outputting the values modelled by the array of output signals as a solution vector of the iterative neural network based model.

17. A method according to claim 16, wherein the convergence condition is met when a first measurement of a property of the array of output signals taken at a first time and a second measurement of a property of the array output signals taken at a second time are within a pre-defined threshold distance to each other.

18. A method according to claim 16, wherein the array of analog input signals is an array of optical input signals, and wherein the analog vector-by-matrix multiplication circuitry is an optical vector-by-matrix multiplier.

19. A method according to claim 16, wherein the iterative neural network based model is a deep equilibrium model.

20. A method according to claim 16, wherein the convergence condition is based on an elapsed time.
